(19) United States
(12) Patent Application Publication
(10) Pub. No.: US 2013/0284679 A1
(43) Pub. Date: Oct. 31, 2013

(54) GREYWATER TREATMENT AND REUSE SYSTEM

(71) Applicants: Stuart L. Bailin, Clarendon Hills, IL (US); James Sharp, Chicago, IL (US)

(72) Inventors: Stuart L. Bailin, Clarendon Hills, IL (US); James Sharp, Chicago, IL (US)

(73) Assignee: WATER HARVESTING SOLUTIONS, INC. (WAHASO), Hinsdale, IL (US)

(21) Appl. No.: 13/456,066

(22) Filed: Apr. 25, 2012

(51) Int. Cl. B01D 29/00; B01D 37/00

(52) U.S. Cl. 210/767; 210/416.1

(57) ABSTRACT

A greywater treatment and reuse system includes a collector for collecting greywater, a distributor for distributing treated greywater for reuse, and a treatment and storage device for treating collected greywater and for storing treated greywater before the greywater is sent to the distributor for reuse. The treatment and storage device is fluidly connected to the collector by a delivery line and is fluidly connected to the distributor by a distribution line. The treatment and storage device includes a first filter that is fluidly connected to a second filter by a connection line and a chlorinator fluidly connected to the delivery line, the chlorinator injecting a first dose of chlorine into the delivery line.

### BACKGROUND

1. Field of the Disclosure

The invention generally relates to water recycling systems and more particularly to greywater treatment and reuse systems.

2. Related Technology

As the human population increases, ever greater demands are being put on natural resources. Food production and energy production systems are being taxed, resulting in food and power shortages. Another natural resource that is becoming scarce is safe fresh water. Water shortages have been experienced worldwide in recent years as population centers exhaust their supplies of fresh water. Water shortages have a destabilizing effect on local economies and may even lead to international conflicts.

Approximately 80% of the world's population lives in areas having vulnerable water supplies. Excessive human water use can detrimentally affect wildlife, such as migrating fish, as well as causing depletion of fresh water sources. Furthermore, dense population centers require extensive water delivery infrastructure. Good management of fresh water resources can protect wildlife while increasing water security.

Increases in population can result in water crises during droughts when water demand exceeds natural water replenishment of fresh water supplies. Generally, rainfall comes from complicated internal processes in the atmosphere that are very hard to predict because of the large amount of variables. As population increases, naturally occurring periods of lower rainfall may result in water shortages as demand exceeds supply.

Although an overwhelming majority of the planet is composed of water, 97% of this water is constituted of saltwater. The fresh water used to sustain humans is only 3% of the total amount of water on Earth. Therefore, the Earth has a limited supply of fresh water, which is stored in aquifers, in surface reservoirs and in the atmosphere. While seawater may be desalinated to render the water potable or useable by humans, only a very small fraction of the world's water supply derives from desalination because desalination is an expensive, energy intensive process.

Fresh water supplies may be better managed through conservation efforts, such as water reclamation and water recycling. In some cases, demand on fresh water supplies may be reduced by reclaiming water that would otherwise go unused. One reclamation process is collecting rainwater in containers and storing the collected rainwater for later use. Water recycling, on the other hand, may be used by virtually any population, even those located in areas that receive little rainfall. Water recycling includes reusing or repurposing water that is used during human activities.

Generally, daily human water use produces two categories of wastewater, which are known as “greywater” and “blackwater.” Blackwater is wastewater that includes biological human waste, such as feces and urine or is water heavily loaded with other contaminants such as food waste or wash water discharge from the wash cycle of a clothes washing machine. Blackwater is produced by toilets and other human waste collectors and requires extensive treatment before being released back into the environment due to its high organic content, dissolved solids, and contamination by various pathogens. Greywater, which is generated from domestic activities such as the rinse cycle of clothes washing machines, lavatory use, and bathing, requires less treatment as greywater generally contains fewer organic compounds than blackwater and generally includes less pathogen contamination. Greywater is produced by lavatory sinks, showers, the rinse cycle of clothes washing machines, and some industrial light use processes, etc.

Greywater may he used for many purposes that would otherwise use fresh, potable water. For example, untreated greywater may be used for flushing toilets and irrigating outdoor plants. Using treated greywater to flush toilets, for example, instead of using fresh, potable water, can reduce the daily use of fresh, potable water by up to 30% in a typical family home.

As demands for potable water increase, communities will rely more heavily on water conservation efforts that include water recycling. Greywater recycling may become a key component of a water recycling system. In fact, some governments are incentivizing water conservation efforts by legislating tax breaks for reduction in fresh potable water usage from the community water supply. Recycling or repurposing greywater is often one component of such programs.

Current greywater recovery systems are generally limited to repurposing untreated greywater for irrigation purposes. Such systems are relatively simple, only requiring a separation of the greywater from the blackwater before the two are mixed. Then, the greywater is diverted outside for irrigation. These systems require that any irrigation be done through sub-surface methods to minimize risks to public health and such systems are generally prohibited from storing greywater for more than about 24 hours. Most current greywater recovery systems do not treat greywater for indoor reuse.

Untreated greywater is heavily regulated by local health regulations, which generally restrict the uses for untreated greywater due to potential public health issues. In many localities, contact of untreated greywater with humans is prohibited and thus, using untreated greywater for indoor or above ground irrigation use is not possible.

### SUMMARY OF THE DISCLOSURE

A greywater treatment and reuse system includes a collector for collecting greywater, a distributor for distributing treated greywater for reuse, and a treatment and storage device for treating collected greywater and for storing the treated greywater before the treated greywater is sent to the distributor for reuse. The treatment and storage device, which may be fluidly connected to the collector by a delivery line and fluidly connected to the distributor by a distribution line, includes a first filter that is fluidly connected to a second filter by a connection line and a chlorinator fluidly connected to the delivery line, the chlorinator injecting a first dose of chlorine into the delivery line.

In another embodiment, the treatment and storage device includes a storage tank fluidly connected to the second filter by a storage line and the chlorinator is fluidly connected to the storage line, the chlorinator injecting a second dose of chlorine into the storage line.

A method of treating and reusing greywater includes collecting greywater from a source of greywater, injecting a first dose of chlorine into the collected greywater upstream of a first filter in the treatment and storage device, filtering the collected greywater in the first filter to remove larger particulate in the collected greywater, filtering the collected greywater in a second filter to remove additional particulate in the collected greywater, storing the filtered greywater in a storage tank, and distributing the stored greywater to a plurality of indoor or outdoor water using devices.

### BRIEF DESCRIPTION OF THE DRAWINGS

FIG. 1 is a general schematic representation of a greywater treatment and reuse system.

FIG. 2 is a detailed schematic representation of the greywater treatment and reuse system of FIG. 1.

FIG. 3 is a perspective view of a filter of the greywater treatment and reuse system of FIG. 2, the filter being mounted on a portable skid.

FIG. 4 is a perspective view of the filter of FIG. 3 connected with a pathogen treatment device, which is also mounted on the portable skid.

FIG. 5 illustrates one embodiment of a controller for the greywater treatment and reuse system of FIGS. 1 and 2.

FIG. 6 is a diagram of a plurality of software routines that may be executed by the controller of FIG. 5.

### DETAILED DESCRIPTION

A greywater collection and treatment system generally collects greywater from a greywater source, such as sinks, showers, dishwashers, or the rinse cycle of clothes washing machines, treats and stores the greywater, and distributes the treated greywater for reuse. The treated greywater may be used, for example, to flush toilets, thereby reducing consumption of potable fresh water. The treated greywater may be used for other purposes, such as for water in clothes washing machines, above-ground spray irrigation systems, and some light industrial processes.

The benefits of collecting or harvesting greywater, treating the collected greywater, and reusing the treated greywater go far beyond fulfilling a desire to be “green.” Collecting, treating, and reusing greywater can have lasting economic benefits for building owners and for communities in general. By reusing treated greywater to flush toilets or urinals, to irrigate landscaping, or to support other water-intensive operations, municipal water charges can be significantly reduced. Wastewater treatment fees and environmental impact fees can also be reduced. Additionally, large scale reuse of greywater may stretch supplies of potable freshwater for communities, which extends the natural resource of water while simultaneously reducing individual water costs.

In high density buildings, the greywater treatment and reuse system advantageously provides a relatively constant supply of treated greywater for flushing toilets. In some cases, the supply of treated greywater can meet 100% of toilet flushing requirements for a particular building. Because the supply of greywater is steady and predictable, storage requirements are reduced, saving storage space and cost. In other words, the predictable nature of greywater production in high density buildings allows the greywater treatment and reuse system to be tailored in capacity for a particular building so that the supply of treated greywater generated by the greywater treatment and reuse system closely matches the demand for treated greywater (i.e., so that supply virtually matches demand), which reduces the need for storage of the treated greywater.

Greywater (also referred to as grey water, gray water and graywater), as used herein, refers to water that is produced by human domestic operations and that does not include significant concentrations of human biological waste (i.e., urine and feces). Greywater is generally produced by sinks, showers, baths and light industrial applications, such as the rinse cycle of clothes washing machines and, and has not yet been treated (e.g., filtered and/or chemically treated) for pathogens.

When properly filtered and stored, greywater can be a valuable source of water to flush toilets, to flush urinals, or to irrigate landscaping. Toilet flushes can account for 25-65% or more of the total water use in a commercial building, even when low-flush fixtures are used.

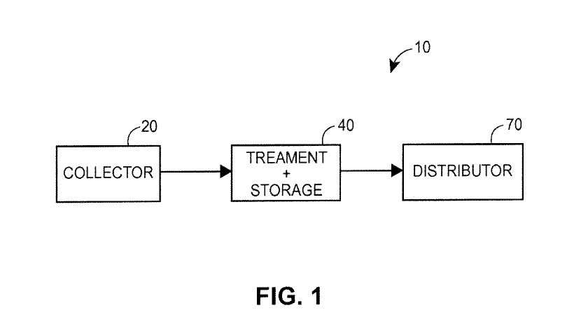

Turning now to FIG. 1, a greywater treatment and reuse system 10 generally includes a greywater collector 20, a treatment unit or treatment and storage device 40, and a distributor 70. The greywater collector 20 (typically a sump or small tank) collects greywater from greywater sources, such as sinks, showers, and the rinse cycle of clothes washing machines or dishwashing machines. The treatment and storage device 40 treats the collected greywater (mechanical)y and/or chemically) and stores the collected and treated greywater. The treatment and storage device 40 includes an active filter, a pathogen treatment device (e.g., a chlorine delivery device), and a storage tank. The distributor 70 distributes treated and stored greywater to indoor and outdoor water using devices or systems (e.g., toilets, urinals, laundry machines, and irrigation systems) by means of a booster pump(s). The greywater treatment and reuse systems described herein may be particularly useful in high density buildings, such as in apartments, dormitories, hotels, office buildings, other commercial buildings, military barracks, and schools as well as single or multi-family residential properties. Some manufacturing facilities may benefit from the disclosed greywater treatment and reuse systems if the greywater produced by the manufacturing operation is not heavily loaded with chemical contaminants.

Greywater harvesting is of great benefit in regions that have relatively low annual rainfall, such as the southwestern, western, and southeastern United States or other areas having similar climates. In areas having low annual rainfall, rainwater harvesting may be impractical. Greywater harvesting in these areas may reduce the burden on subterranean water supplies.

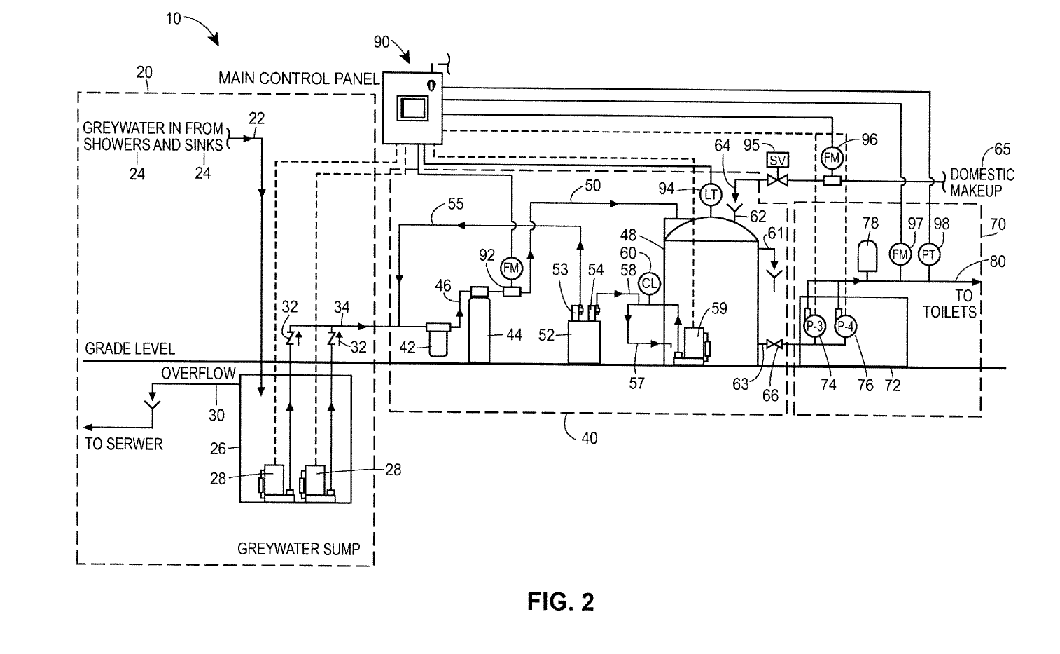

FIG. 2 illustrates a schematic diagram of an example greywater treatment and storage system 10 including the collector 20, the treatment and storage device 40, and the distributor 70. The collector 20 generally harvests or collects greywater and sends the collected greywater to the treatment and storage device 40. The treatment and storage device mechanically filters and chemically treats the collected greywater and stores filtered and treated greywater for future use. On demand, the distributor 70 pumps stored treated greywater from the treatment and storage device 40 and delivers the treated greywater to downstream components, such as toilets for reuse. The greywater treatment and storage system 10 advantageously reduces consumption of potable water, which reduces water expenses while preserving natural sources of fresh water.

In the system illustrated in FIG. 2, the collector 20 is an active greywater harvesting device, which includes a mechanical means of collecting, storing and pumping harvested greywater. The collector 20 includes a plurality of collection lines 22 that are fluidly attached to various sources of greywater 24, such as showers and sinks, and that direct collected greywater into a greywater sump 26, where collected greywater is temporarily stored. A plurality of collector pumps 28 are disposed at a low point in the greywater sump 26 and operate to pump greywater out of the greywater sump 26 on demand, to the treatment and storage device 40.

In one embodiment, the collector pumps 28 operate to move greywater out of the greywater sump 26 when a minimum level of greywater is reached. By pumping greywater out of the sump 26 when a minimum level is reached, the collector pumps 28 prevent greywater in the greywater sump from becoming stagnant, which minimized bacterial growth in the greywater sump 26. If a minimum level of greywater is not reached in the greywater sump 26 over a predetermined period of time (e.g., 24 hours), the collector pumps 28 may operate to clear the greywater out of the greywater sump 26 to prevent stagnation.

The greywater sump 26 may include an overflow line 30 that is connected to a community sewer. For example, in the event that both collector pumps 28 become inoperative, such as during power loss or mechanical failure, or in the event that the supply of greywater surpasses the processing capability of the treatment and storage device 40, the overflow line 30 prevents backup of greywater within the collector 20. One or more check valves 32 may be located in a delivery line 34, which fluidly connects the greywater sump 26 with the treatment and storage device 40. The check valves 32 prevent backflow of greywater from the treatment and storage device 40 into the greywater sump 26.

Harvesting greywater has many system and regulatory implications not associated with rainwater or condensate harvesting. Unlike other renewable water sources, greywater normally contains biological and chemical contaminants that can quickly turn the water to septic “blackwater,” resulting in unpleasant odors, colors and health hazards if not treated correctly. The greywater treatment and reuse system 10 treats or filters these biological and chemical contaminants in the treatment and storage device 40.

In particular, the treatment and storage device 40 uses filtration, sterilization, and chemical monitoring to bring the collected greywater to near-potable quality, which reduces or eliminates health and esthetic concerns while meeting regulatory requirements. Furthermore, the treated greywater becomes safe to store for certain periods of time without the risk of the treated greywater turning septic.

The treated greywater produced by the greywater treatment and storage system 10, in some embodiments, meets or exceeds industry standards for on-site treated non-potable water. More specifically, the treated greywater meets or exceeds NSF-350 commercial greywater treatment standard, which includes turbidity of less than 2 NTU; suspended solids of less than 10 mg/L; E Coli of less than 2.2 MPN/100 mg/L; CBOD of less than 10 mg/L; and residual chlorine level of between 0.5 and 1 PPM.

Generally speaking, the treatment and storage device 40 includes a first filter 42 fluidly connected to a second filter 44. Greywater is pumped to the first filter 42 from the greywater sump 26 through the delivery line 34. After exiting the first filter 42, the greywater proceeds to the second filter 44 through a connection line 46, which fluidly connects the first filter 42 with the second filter 44. After exiting the second filter 44, the greywater travels to a storage tank 48 through storage line 50, which fluidly connects the second filter 44 to the storage tank 48, where the greywater is stored until needed.

The first filter 42 is a course filter, which removes large particles, such as hair or dirt, from the greywater. The large particles removed by the first filter 42 may be about 200 microns or greater, preferably about 100 microns or greater. The first filter 42 may be a bag filter or automatic self cleaning filter. In one embodiment, the first filter 42 may be a bag filter having a one-piece body that holds a single bag, such as the Flowline™ filters manufactured by Eaton. The first filter 42 may be rated for pressures up to 150 psi at temperatures of up to 250° F.

The second filter 44 removes all particulates greater than about 25 microns in size, preferably all particles greater than about 15 microns in size, and more preferably all particles greater than about 5 microns in size. In one embodiment, the second filter 44 may be a multi-media filter, such as the MFG Packaged Water Filters (in particular the MID 2750 XT series filters) manufactured by Marlo Incorporated. The second filter 44 may include a fiberglass filter tank or ASME rated metal tank, a motorized valve assembly, a filter media bed, and an automatic bypass. The second filter 44 may also include a self-adjusting backwash controller that minimizes maintenance by automatically and periodically executing a backwash cycle that flushes filtered debris to a sewer system and that resets the multi-media. The second filter 44 may be capable of filtering between about 8 gpm and about 105 gpm of greywater, preferably between about 20 gpm and about 100 gpm, and more preferably between about 50 gpm and about 100 gpm of greywater. The second filter 44 may be configured to operate between about 30 psi and about 125 psi at temperatures up to about 110° F. The second filter 44 may operate on 110 V or 220 V power, requiring about 10 Watts of power. In some embodiments, the second filter 44 may include a differential pressure sensor that activates the backwash cycle when a maximum differential pressure is detected. In other embodiments, the self-adjusting backwash controller may operate the backwash cycle based on time.

Because of the contaminants generally found in greywater, residual sterilization capacity is beneficial in keeping the system clean. Chlorination using calcium hypochlorite in the form of solid briquettes is preferred, although other methods of chlorination or chemical sterilization may be used. Calcium hypochlorite in a liquid solution is similar to sodium hypochlorite used in a municipal water treatment systems but calcium hypochlorite takes on a form that is safer and easier for building maintenance staff to handle.

Generally speaking, the calcium hypochlorite in solid form is dissolved in water to produce a highly concentrated liquid solution. The level of free chlorine in the highly concentrated solution may be controlled and the highly concentrated liquid solution is stored in a reservoir for later delivery to the greywater for treatment by one or more dosing pumps.

To facilitate the chlorination process, the treatment and storage device 40 includes a chemical treatment device or chlorinator 52, which includes a source of chlorine, a first chlorine dosing pump 53, and a second chlorine dosing pump 54. The first and second chlorine dosing pumps 53, 54 deliver chlorine from the source of chlorine to greywater flowing through the greywater treatment and reuse system 10 at certain locations within the treatment and storage device 40. For example, the first chlorine dosing pump 53 delivers a first dose of chlorine through a first dosing line 55 to be injected into the greywater upstream of the first filter 42, for example in the delivery line 34. This first dose of chlorine kills any pathogens in the greywater so that the pathogens do not become embedded in the filters 42, 44, and/or so that the pathogens do not produce any foul odors. The second chlorine dosing pump 54 delivers a second dose of chlorine through a second dosing line 58 to a circulation loop 57 connected to the storage tank 48. This second dose of chlorine is optional and may be required if the second filter 44 includes media that would react with the first dose of chlorine. Some multi-media filters may include chemicals or other substances that react with, or otherwise sequester, chlorine, thereby rendering the first dose of chlorine ineffective downstream of the second filter. For example, some multi-media filters include anthracite that sequesters chlorine within the second filter. More particularly, anthracite removes free chlorine from the greywater flowing through the second filter, which leaves greywater downstream of the second filter (e.g., in the storage tank 48) vulnerable to pathogen growth. The second dose of chlorine restores chlorine levels downstream of the second filter 44 to levels that are sufficient to prevent pathogens from growing in the filtered greywater.

A recirculating pump 59 may continuously (or periodically) pump stored greywater from the storage tank 48 through the circulation loop 57. A chlorine sensor 60 may sense chlorine levels in the greywater circulating in the circulation loop 57. When the chlorine sensor 60 detects a level of free chlorine in the greywater that is below a predetermined or user selected threshold, the second chlorine dosing pump 54 may be activated to deliver the second dose of chlorine. The circulation loop 57 and the recirculating pump 59 cooperate to keep greywater in a storage tank 48 thoroughly mixed, which helps keep chlorine level uniform and helps prevent minerals or other compounds from forming scale or sludge on the interior surfaces of the storage tank 48.

Storage methods and/or sizes of storage tanks for treated greywater may be customized to fit the demands and uses for the treated greywater water, available greywater volume and turnover frequency, and space to locate any storage tanks.

The storage tank 48 may have a connection to a municipal water source 65 through a make-up line 64 so that toilet flushing can occur even if there is not an adequate supply of stored greywater to meet toilet needs. However, in typical applications for toilet flushing, there is more than enough supply of greywater from showers, sinks, and baths to meet flushing needs.

In some embodiments, the storage tank 48 may be pre-mounted on a skid for ease of installation with all internal piping manifolds and sensors mounted and pre-tested. The storage tank 48 may be NSF-61 rated for potable water even though the storage tank 48 is being used to store non-potable treated greywater. Larger underground storage tanks may be considered if the greywater collector generates significant volumes of greywater.

During periods of low greywater production, makeup water may be provided through a makeup line 64 to ensure that an adequate supply of water exists in the storage tank 48 to supply any devices that use the greywater, such as toilets and urinals. An air gap is formed between the makeup line 64 and a makeup inlet 62 to prevent the possibility of backflow (cross-contamination) of greywater from the storage tank 48 into the domestic water supply. In other embodiments a one-way check valve may be substituted for the air gap. The storage tank 48 also includes an overflow outlet 61, which vents treated greywater out of the storage tank 48 when a level of greywater within the storage tank 48 exceeds a predetermined level.

The distributor 70 may include duplex pumps mounted on a pump skid 72. A first distribution pump 74 and a second distribution pump 76 may be identical commercial grade pumps that operate in tandem with one another, each pump being rated at 70% of peak demand. In other embodiments, the first and second distribution pumps may have different pumping capacities. An operating system 90 may alternate operation of the first and second pumps 74, 76. If a high demand situation occurs, both the first and second pumps 74, 76 may be used to meet the demand. If one pump should fail, the other pump will continue to provide treated greywater to downstream components.

The storage tank 48 is fluidly connected to the distributor 70 with a distribution supply line 63. The distribution supply line 63 may include a pressure sensor to control pump speed. The distribution line may also include an isolation valve 66 operates to fluidly separate the distributor 70 from the treatment and storage device 40. A bladder pressure tank 78 may be fluidly connected to a distribution line 80, which directs treated greywater to downstream devices, such as toilets and urinals. The bladder pressure tank 78 acts as a shock absorber for the distributor by storing an amount of treated greywater under pressure for release to the distribution line 80 on demand. The bladder pressure tank 78 also reduces stress on the first and second distribution pumps 74, 76 by limiting cycle times.

The controller 90 monitors and controls the overall operation of the greywater treatment and reuse system 10. The controller 90 may comprise a programmable logic controller (PLC) that fully automates and controls the process for greywater treatment and reuse. Software used by the PLC may be customized for each individual application and may provide the capability of interfacing with other existing building systems and/or alarm and condition monitoring systems.

In addition to monitoring and controlling system operations, the controller 90 may track the amount of treated greywater in individual storage tanks and track and display periodic (e.g., monthly) treated greywater use and collection. The controller 90 may include a web interface that allows remote monitoring of the system for maintenance or educational purposes. Remote monitoring may also be used to diagnose potential system problems.

The controller 90 may be operatively connected via a wired or a wireless connection to the collector pumps 28, the recirculating pump 59, and the distribution pumps 74, 76. The controller 90 may optionally be communicatively connected to the chlorine dosing pumps 53, 54, if desired. In the embodiment of FIG. 2, the chlorine dosing pumps 53, 54 are controlled by an onboard chlorine controller (not shown in FIG. 2). The controller 90 may also be communicatively connected via a wired or a wireless connection to various sensors and valves. For example, the controller 90 may be communicatively connected to a flow meter 92, which measures a flow rate of treated greywater exiting the second filter 44. If the flow meter 92 indicates a low flow condition (i.e., a flow rate below a threshold value), the controller may turn off the greywater transfer pumps 28 as the low flow condition indicates a problem with one or both of the filters 42, 44. In most cases, a low flow condition indicates that one or more of the filters 42, 44 needs to be cleaned. Differential pressure sensors at the filters also send an alarm condition when the filters require service.

Similarly, the controller 90 may be communicatively connected to a level sensor 94 in the storage tank 48. If the level sensor 94 indicates a low level of treated greywater in the storage tank 48, the controller 90 instructs the collector pumps 28 to turn on, which will supply treated greywater to the storage tank 48. If there is insufficient greywater in the sump 26 to begin pumping, the controller may instruct a solenoid valve 95 to open, which supplies makeup water to the storage tank 48 to ensure sufficient water is present in the storage tank 48 to supply downstream water consuming components. The controller 90 may be communicatively connected to a makeup flow meter 96 located in the makeup line 64 to ensure that makeup water is flowing into the storage tank 48 if needed and to provide data of backup water used.

Finally, the controller 90 may be communicatively connected to a distribution flow meter 97 and a distribution pressure transmitter 98 so that the controller 90 may monitor greywater flow and distribution in the distribution line 80. If the flow meter 97 indicates low flow, or if the pressure transmitter 98 indicates low pressure, the controller 90 may communicate a problem with the distribution system to a user. The controller 90 may communicate the problem by issuing an alarm, or by displaying an error message on a display. Flow Meter 97 in conjunction with Flow Meter 96 and Flow Meter 92 log key water collection and use data for use by the owner in evaluating the system performance.

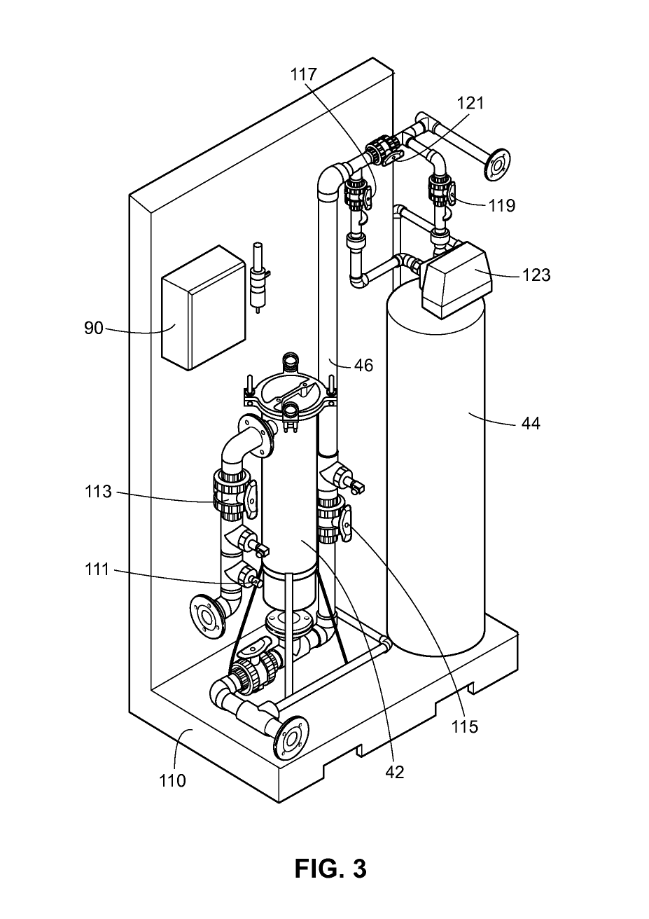

FIG. 3 illustrates one embodiment of a portion of the treatment and storage device 40 that is mounted on a transportable skid 110. Skid mounting portions of the treatment and storage device 40 facilitates system installation and/or component replacement. As illustrated in FIG. 3, the first filter 42 and the second filter 44 may be located on the skid 110. The first filter 42 is fluidly connected to the second filter 44 by the connection line 46. A chlorine injection input 111 is located upstream of the first filter 42. A first shutoff valve 113 is also located upstream of the first filter 42. The first shutoff valve 113 may be used to stop greywater flow through the first and second filters 42, 44, during maintenance or repair operations. In the embodiment of FIG. 2, the second filter 44 carries an on-board controller 123, which controls backwash cycles for the second filter 44 on a periodic basis or on a pressure differential basis. Valves 117, 119, and 121 route water to the on-board controller 123 for purposes of backflushing the filter and during normal filtering operation.

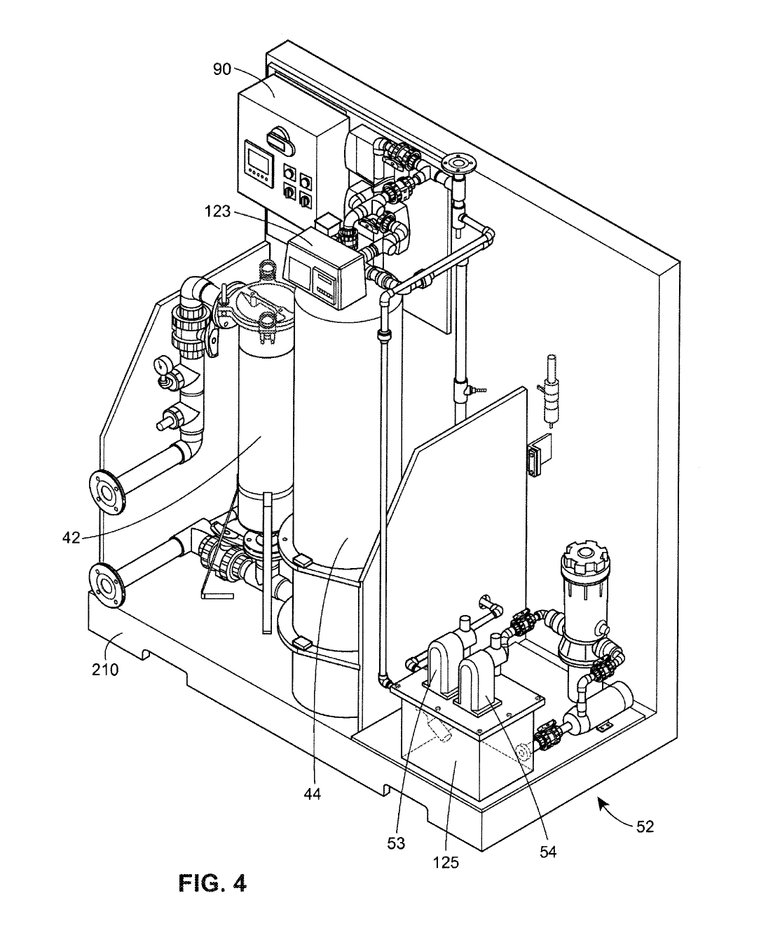

FIG. 4 illustrates an alternate embodiment of a portion of the treatment and storage device 40 mounted on a transportable skid 210. Similar to the embodiment of FIG. 3, both of the first and second filters 42, 44 are mounted on the transportable skid 210. Additionally, the chlorinator 52 is also mounted on the transportable skid 210. The chlorinator 52 includes the first and second chlorine dosing pumps 53, 54, which are mounted on a chlorine tank 125. The controller 90 may also be optionally mounted on the transportable skid 210, which further facilitates installation and system repair.

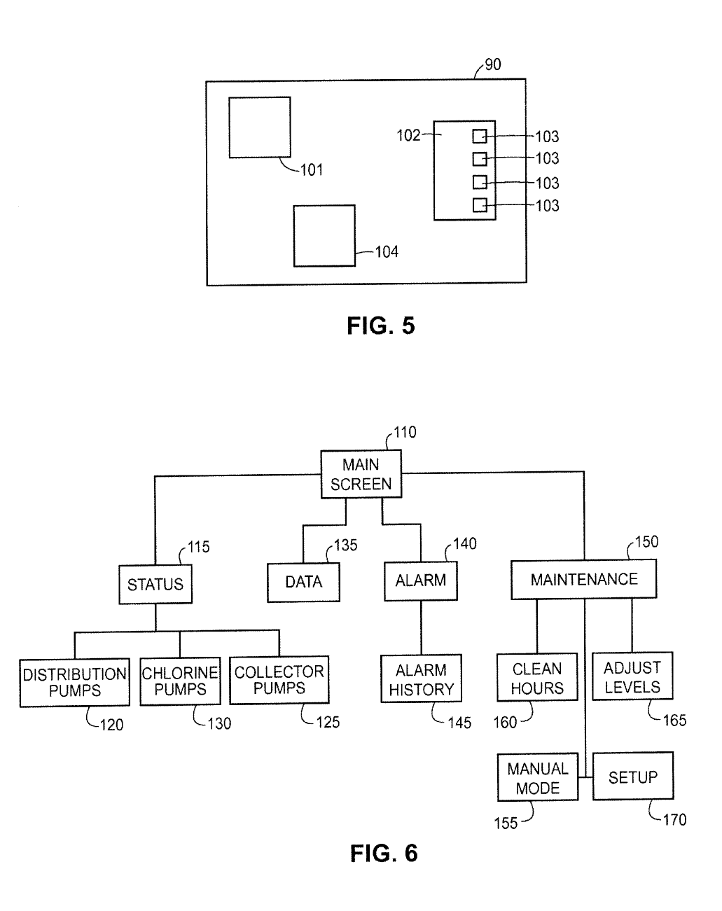

FIG. 5 illustrates one embodiment of a controller 90. The controller 90 may include a processor 101 that is operatively connected to an input-output device manager 102. The input-output device manager 102 may include a plurality of software routines 103 that are executable by the processor 101. An operator interface device 104, such as a touch-screen display, may be operatively connected to the processor 101 for a user to input certain instructions to the processor 101, such as instructions to execute one or more of the software routines 103, or for a user to receive information from the processor 101, such as pressure or flow sensor readings that are received from various sensors throughout the greywater treatment and reuse system 10. Furthermore, the operator interface device 104 may be used to communicate other system information to the user, such as component malfunctions.

FIG. 6 illustrates a plurality of the software routines 103 that may be executed by the controller 90 during operation of the greywater treatment and reuse system 10 of FIGS. 1 and 2. A main screen routine 110 is the initial routine executed by the processor 101 of the controller 90. Four main routines may be accessed through the main screen routine 110. For example, the main screen routine 110 allows access to a status routine 115, a data routine 135, an alarm routine 140, and a maintenance routine 150. In other embodiments the main screen routine 110 may allow access to other routines.

As discussed above, the purpose of the main screen routine 110 is to allow a user to navigate to the main routines (e.g., the status routine 115, the data routine 135, the alarm routine 140, and the maintenance routine 150). Additionally, a user can change or input a system date and/or time from the main screen routine 110. The main screen routine 110 also instructs the input/output device 104 to display a system status enunciator, which may indicate a system status. For example, the system status enunciator may indicate that the system is stopped, is in automatic operation, or is in manual operation. As a result, the user can quickly identify the system operational status. The main screen routine 110 may also instruct the input/output device 104 to display the current system software version.

The status routine 115 displays a schematic illustration of the system including operational status of various system components and/or sensor readings such as flow rates or pressures throughout the system on the input/output device 104. The status routine 115 communicates with various system components and sensors and then compiles component and sensor information for display on the input/output device 104. The status routine 115 may also allow a user to access certain sub-routines for changing operating parameters of various components. For example, the status routine 115 may allow a user to access a distribution pump routine 120, a chlorine pump routine 130, and a collector pump routine 125 so that various operating parameters of the distribution pumps 74, 76, the chlorine dosing pumps 53, 54, and the collector pumps 28 may be viewed, modified or adjusted.

In particular, a distribution pump routine 120 may be used to observe current operating parameters of the distribution pumps 74, 76, and/or to change various operating parameters of the distribution pumps 74, 76. For example, the distribution pump routine 120 may send instructions to the input/output device 104 to display pump output pressure from the pressure sensor 98 (FIG. 2), pump output flow rates from the flow meter 97, and/or motor speed from variable frequency drives within the distribution pumps 74, 76. These or other operational parameter displays may be useful in ascertaining the overall operating condition of the distributor 70. Moreover, the user may change various operating parameters of the distribution pumps 74, 76 from the distribution pump routine 120. For example, the distribution pump routine 120 may allow the user to adjust pump output pressure and/or motor speed of the distribution pumps 74, 76. Additionally, a user may manually shut down one of the distribution pumps 74, 76, through the distribution pump routine 120, for example, if maintenance must be performed on a particular pump. The distribution pumps 74, 76 normally run one at a time because a single pump has sufficient pumping capacity to supply treated greywater to downstream system components. After one pump 74, 76 runs for a predetermined amount of time (e.g., 100 hours), the distribution pump routine 120 may switch to the other pump to put similar loads on the pumps over time. A user may change the predetermined amount of time from the distribution pump routine 120.

The collector pump routine 125 may be used to manually turn off or turn on the individual collector pumps 28. Normally, one collector pump 28 runs at a time and the collector pumps switch between one another after a predetermined amount of time (e.g., 100 hours), similar to the operation of the distribution pumps 74, 76 discussed above. The user may adjust the predetermined time period, or the user may manually turn on or turn off the individual collector pumps 28 through the collector pump routine 125.

The chlorine pump routine 130 may be used to monitor the chlorine dosing pumps 53, 54, and/or to adjust operating parameters of the chlorine dosing pumps 53, 54. In particular, the chlorine pump routine 130 may send instructions to the input/output device 104 to display current speeds of the chlorine dosing pumps 53,54 and/or to display current chlorine concentration readings from the chlorine sensor 60 (FIG. 2). The user may adjust a desired chlorine level from the chlorine pump routine 130. For example, the user may select free chlorine levels generally corresponding to acceptable municipal water free chlorine levels. More specifically, the user may select free chlorine levels in the storage tank 48 of between about 0.5 ppm and about 1.0 ppm. The user may also select a minimum free chlorine level at which the system switches to the municipal water supply 65. For example, the user may select a minimum free chlorine level of less than about 0.15 ppm. The system may automatically switch over to the municipal water supply 65 when the minimum free chlorine level is reached for any reason, for example, when the leak in the distribution line, the user may want to turn off the supply of make-up water by closing the solenoid valve 95 to prevent continued loss of water through the leak. The alarm routine 140 may also access an alarm history routine 145, which stores historical information relating to previous alarms.

The maintenance routine 150 may be used to clear any alarms that were activated by the alarm routine 140. After the fault condition has been corrected (e.g., a leak has been fixed or a pump has been replaced or serviced), the user may clear the alarm by pressing a clear fault button that is displayed on the input/output device 104. Several sub-routines (e.g., a manual mode routine 155, a clear hours routine 160, an adjust levels routine 165, and a setup routine 170) may be accessed through the maintenance routine 150.

The manual mode routine 155 allows a user to manually activate a particular pump, or a certain mode of operation. For example, a user may manually turn on or manually turn off one or more of the distribution pumps 74, 76, the chlorine dosing pumps 53, 54, the collector pumps 28, or the recirculating pump 59. Additionally, a user may manually open or manually close the solenoid valve 95 or a flush valve (not shown).

The clear hours routine 160 may be used to clear historical run time information for the various pumps in the system. This feature may be useful when a pump is overhauled or replaced.

The adjust levels routine may be 165 used to adjust levels at which the solenoid valve 95 opens and closes to allow make-up water to enter the storage tank 48. Additionally, liquid levels in the sump 26 may be set at which the collector pumps 28 turn on and turn off to send collected greywater to the treatment and storage device 40.

The setup routine 170 may be used to set initial system parameters, such as sump 26 minimum and maximum levels, sump 26 total capacity, storage tank 48 minimum and maximum levels, storage tank 48 total capacity, time between switching collector pumps 28, time between switching distribution pumps 74, 76, and any other initial operating parameters.

The controller 90 and various software routines allow the greywater treatment and reuse system 10 to seamlessly and continuously supply downstream components (e.g., toilet cisterns) with treated greywater, thereby reducing potable water requirements and preserving our natural freshwater resources.

In one embodiment, the greywater treatment and reuse system 10 may be fully automated and designed to operate independently and efficiently. The treatment and storage device is easy to operate and maintain by utilizing NSF 61 approved dry chlorine pellets. Equipment skids are built using industrial-grade UL and NSF approved components, which makes installation and/or component replacement quick and easy.

In another embodiment, the greywater treatment and reuse system 10 may be easily connected to buildings having separate greywater and blackwater plumbing. In some locations, local governments have begun to require new buildings to have separate greywater and blackwater plumbing. For example, the city of Tucson, Ariz. now requires all new residential and commercial properties to include separate greywater and blackwater plumbing. The disclosed greywater treatment and reuse system 10 may be quickly and easily installed in such buildings.

The treated greywater produced by the greywater treatment and reuse system meets industry standards for “on-site treated non-potable water.” This type of treated greywater is allowed by most municipal codes to be used for certain indoor uses, such as flushing toilets, where non-treated greywater may not be used.

Although certain greywater treatment and recovery systems have been described herein in accordance with the teachings of the present disclosure, the scope of the appended claims is not limited thereto. On the contrary, the claims cover all embodiments of the teachings of this disclosure that fairly fall within the scope of permissible equivalents.

1. A greywater treatment and reuse system comprising:
a collector for collecting greywater, the collector including a greywater sump that is fluidly connected to a plurality of greywater collection lines and a plurality of collector pumps disposed in the greywater sump;
a treatment unit including a first filter fluidly connected to the collector pumps by a delivery line, a second filter fluidly connected to the first filter, a storage tank fluidly connected to the first filter and to the second filter by a storage line, and a chemical treatment device; and
a distributor for distributing treated greywater for reuse, the distributor including duplex treated greywater booster pumps fluidly connected to the storage tank by a distribution supply line, the duplex treated greywater booster pumps pumping treated greywater from the storage tank to a distribution line,
wherein the chemical treatment device is fluidly connected to the delivery line for injecting a first dose of chlorine into the delivery line upstream of the first filter.

2. The system of claim 1, wherein the storage tank includes a recirculating loop for recirculating treated greywater stored in the storage tank.

3. The system of claim 2, wherein the chemical treatment device is fluidly connected to one of the storage tank and the recirculating loop, the chemical treatment device being capable of delivering a second dose of chlorine to one of the storage tank and the recirculating loop.

4. The system of claim 2, wherein the recirculating loop is connected to a recirculating pump.

5. The system of claim 2, further comprising a controller that is operatively connected to at least one of the plurality of collector pumps, the recirculation pump, a chlorine dosing pump in the chemical treatment device, the duplex treated greywater booster pumps, and a solenoid valve in a makeup line that is fluidly connected to the storage tank.

6. The system of claim 5, wherein the controller is communicatively connected to at least one of a flow meter in the storage line, a level sensor in the storage tank, a flow meter in the makeup line, and a pressure transmitter in the distribution line.

7. The system of claim 2, further including a chlorine sensor connected to the recirculating loop, the chlorine sensor detecting a level of chlorine in the recirculating loop.

8. The system of claim 2, further including a flow meter connected to the storage line, the flow meter measuring fluid flow through the storage line.

9. The system of claim 1, wherein the first filter is one of a porous media filter, a settling tank, a screen filter, and a bag filter.

10. The system of claim 1, wherein the second filter is a multi-media filter.

11. The system of claim 10, wherein the second filter includes an automatic backwash controller.

12. The system of claim 10, wherein the second filter includes a differential pressure sensor.

13. The system of claim 1, wherein the storage tank includes a make-up line that is connected to a supply of makeup water.

14. The system of claim 1, wherein the storage tank includes an overflow outlet.

15. The system of claim 1, wherein the storage tank includes a level sensor.

16. The system of claim 1, wherein the distributor includes a bladder pressure tank that is fluidly connected to the distribution line.

17. A method of treating and reusing greywater, the method comprising:
collecting greywater from a source of greywater;
injecting a first dose of chlorine into the collected greywater upstream of a first filter;
filtering the collected greywater in the first filter to remove particulate in the collected greywater;
filtering the collected greywater in a second filter to remove particulate in the collected greywater;
storing the filtered greywater in a storage tank; and
distributing the stored treated greywater to a plurality of water using devices.

18. The method of claim 17, further comprising injecting a second dose of chlorine downstream of the second filter to maintain a desired level of free chlorine in the storage tank, the desired level of free chlorine being is selectable by a user.

19. The method of claim 17, wherein the storage tank includes a recirculating circuit.

20. The method of claim 19, wherein the second dose of chlorine is injected into the recirculating circuit.
